(19) United States
(12) Patent Application Publication
(10) Pub. No.: US 2008/0293453 A1
(43) Pub. Date: Nov. 27, 2008

(54) METHOD AND APPARATUS FOR AN AUDIO-LINKED REMOTE INDICATOR FOR A WIRELESS COMMUNICATION DEVICE

(75) Inventors: Scott J. Atlas, Houston, TX (US); John Brinkmann, Houston, TX (US); John Lahad, Houston, TX (US); Allen Wan, Houston, TX (US)

Correspondence Address: WONG, CABELLO, LUTSCH, RUTHERFORD & BRUCCULERI,;L.L.P., 20333 SH 249, SUITE 600, HOUSTON, TX, 77070, US

(73) Assignee: Scott J. Atlas, Houston, TX (US)

(21) Appl. No.: 11/753,931

(22) Filed: May 25, 2007

(51) Int. Cl. H04M 1/00; G08B 21/00

(52) U.S. Cl. 455/567; 340/870.16

(57) ABSTRACT

A remote ring monitor for a mobile communications device comprises an audio sensor to detect a sound signal emitted by the monitored device and one or more indicators which may provide visual, auditory or tactile alert signals to the user. A plurality of indicators may be used to indicate various different audio signals received. The audio sensor may comprise a microphone, a codec and digital signal processor. In certain embodiments, an encoded ring tone is downloaded to a mobile communications device to be monitored so as to enhance the selectivity of the monitoring device. The audio sensor may be remote from the indicator and the two may be in communication via a radio-frequency link.

### CROSS-REFERENCE TO RELATED APPLICATIONS

NONE

### STATEMENT REGARDING FEDERALLY SPONSORED RESEARCH OR DEVELOPMENT

NONE

### BACKGROUND OF THE INVENTION

1. Field of the Invention

This invention relates to wireless communications devices. More particularly, it relates to remote indicators for alerting a user to an incoming call, message, or the like.

2. Description of the Related Art

Wireless communications devices are now in common use throughout the inhabited portions of the world. Perhaps the most common such devices are cellular telephones and pagers. As the physical size of these devices has decreased, their use has become more personal and the device is often carried on the person. For example, mobile telephones were at first confined largely to vehicles. However, reductions in their size and power requirements have permitted them to fit in a pocket, purse or belt holster.

It is not always convenient, however, to carry a mobile communications device on the person. A user's attire may not have a pocket or belt upon which a device (or its holder) may be clipped. For aesthetic reasons, some users prefer not to have a bulky item like a cellular phone in their pocket or clipped to their belt. As a result, cell phones, pagers and the like are often carried in a purse, attache case, bag or the like. The acoustic insulation provided by such a container in combination with a possible lack of proximity to the user can result in a call or message notification (e.g., phone ringing; pager beeping) being missed by the user. What is needed is a smaller, less obtrusive indicator of an incoming call or message that can be worn on the person or attached to the outside of a purse or bag holding the phone or pager.

Some devices of the prior art have addressed this problem by providing a radio-linked remote indicator that establishes a network connection with a mobile phone. For example, U.S. Pat. No. 7,016,707 to Fujisawa et al. describes a system wherein a mobile telephone and a radio communication device cooperatively process an incoming call. In that system, when there is an incoming call to a mobile telephone, it sends an incoming call notification signal to a watch-shaped information processing device. When the watch-shaped information processing device receives the incoming call notification signal, it notifies its user of the incoming call. The watch-shaped information processing device can also sends user's instructions to the mobile telephone. The instructions cause the mobile telephone to conduct processing for an incoming call such as processing for asking the caller to wait, or asking the caller to leave a message. Such systems typically employ a two-way, radio-frequency link between the mobile telephone and the remote device. This often means that the mobile telephone must be equipped with a [separate] radio transmitter and receiver dedicated to this function—i.e., a phone pre-configured and equipped for use with a remote device.

### BRIEF SUMMARY OF THE INVENTION

A remote device “listens” for an audio signal emanating from a mobile communications device and activates a visual, audio or tactile indicator to alert the user of an incoming call, missed call, page, text message, voice mail, or the like.

In one particular preferred embodiment, a remote indicator responds to the audio reception of a unique ring tone emitted by a mobile phone. The response may be a flashing light on the exterior of the device. Different signals may be used to indicate different incoming calls. For example, a light of a unique color may be illuminated if the call is from a certain number or is a member of a set of known numbers—i.e., from someone known to the user.

In some embodiments, the indicator is in a separate module that is linked to the ring detector via a radio-frequency receiver or transceiver. In such embodiments, the ring detector may be kept in physical proximity to the phone being monitored—e.g., in a purse—while the rf-linked indicator is worn or carried by the user who may be some distance away from the phone.

### BRIEF DESCRIPTION OF THE SEVERAL VIEWS OF THE DRAWING(S)

FIG. 1 illustrates a user modeling various fashion accessories containing a device according to one embodiment of the invention. In the illustration, the user is carrying a handbag containing a mobile communications device having audio signaling capability.

FIG. 2 is an enlarged view of the user's hand with a ring according to one embodiment of the invention being worn thereon.

FIG. 3 illustrates how four different fashion accessories—a necklace, a brooch, a ring and a bracelet—may function as housing embodiments of the invention.

FIG. 4 shows a two-piece embodiment of the invention which employs a radio-frequency link to a remote indicator housed within a fashion accessory.

FIG. 5 is a block diagram of a remote ring monitor according to one embodiment of the present invention.

FIG. 6 is a block diagram of a remote ring monitor system according to an embodiment of the present invention that includes an rf-linked indicator.

FIG. 7 is a flowchart of a method according to the present invention that includes indicating a missed call.

FIG. 8 illustrates the steps in a process for generating and downloading a coded ring tone to a mobile communications device.

FIG. 9 is a flowchart of a method according to the present invention wherein a remote ring monitor is programmed to respond to a certain sampled sound such as the ring tone of a selected mobile communications device.

### DETAILED DESCRIPTION OF THE INVENTION

A device according to the present invention may comprise an audio signal monitor for a mobile communications device that may include a sensor responsive to an audio signal emitted by a selected mobile communications device and an indicator selected from the group consisting of visual indicators, audio indicators and tactile indicators. The indicator may be coupled to the sensor such that the indicator is activated upon receipt by the sensor of a pre-selected audio signal emitted by the selected mobile communications device. In various embodiments the device may comprise analog circuitry and/or digital circuitry.

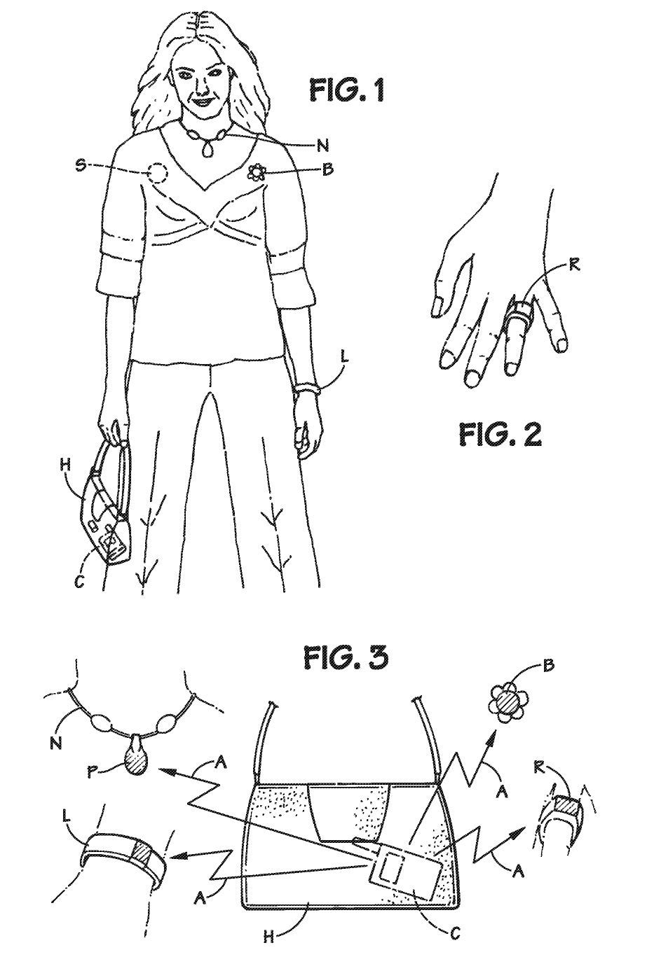

The sensor and indicator may be in a single package or housing or may be in separate housings. FIG. 1 shows a user carrying a cell phone C within handbag H. The ring tone of cell phone C (or other audio alert signal from cell phone C) may be attenuated by handbag H to such an extent that it is not readily apparent to the user. The user may therefore wear an indicator according to the present invention which responds to an audio signal emitted by device C with a separate indication which may be visual, tactile and/or auditory. Such a device may be worn by the user (e.g., as skin patch S) or concealed within an article of clothing or a fashion accessory. Several examples are shown in FIG. 1 such as necklace N, pin or brooch B, or bracelet L. An embodiment using a ring R as a housing is shown in FIG. 2.

FIG. 3 illustrates the audio link A between the mobile communications device C (which may be inside handbag or purse H) and a monitoring device according to the present invention. For example, the sensor and indicator comprising the monitoring device may be concealed and housed within pendant P of necklace N, within a segment of bracelet L, inside brooch B or incorporated in ring R.

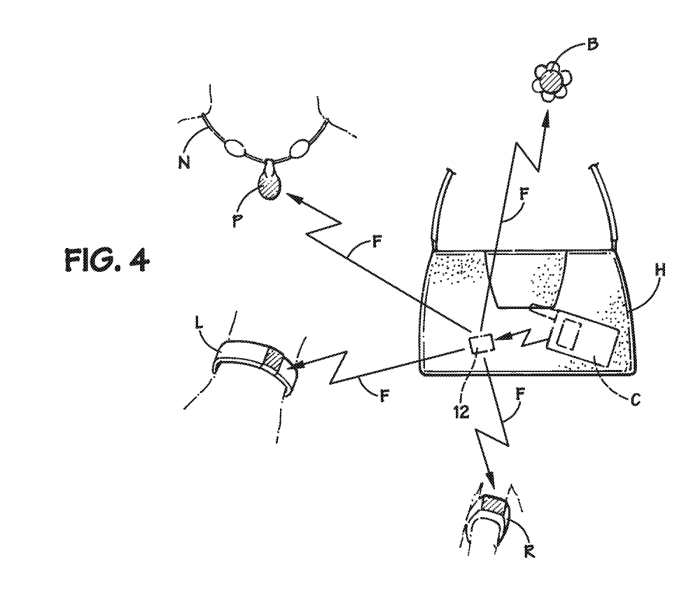

FIG. 4 illustrates one alternative embodiment wherein the sensor is within package 12 and the indicator is remotely located, for example within pendant P of necklace N, inside brooch B, incorporated in finger ring R or within bracelet L. The sensor may activate the indicator by means of radio-frequency link F. In this way, sensor housing 12 may be kept in proximity to mobile communications device C so as to provide enhanced sensitivity and selectivity while the sensor element may be smaller and thus more readily incorporated into certain fashion accessories.

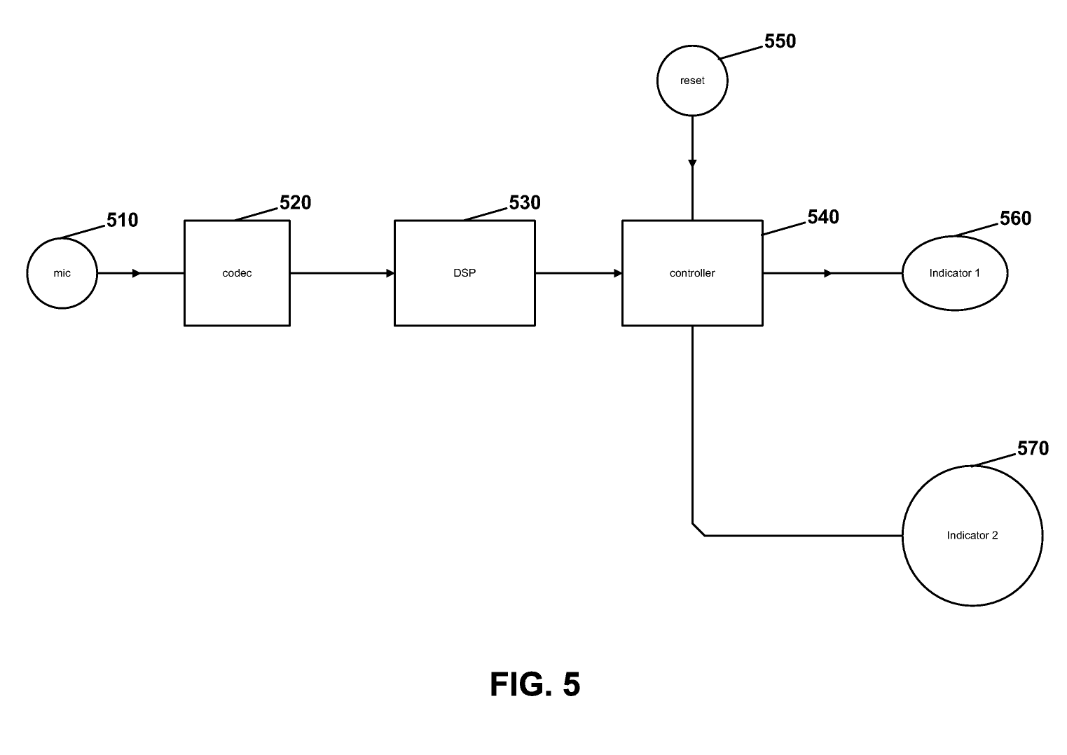

FIG. 5 shows a remote ring monitor according to one embodiment of the present invention in block diagram form. Audio sensor 510 may be a microphone the output of which is input to coder/decoder circuit (codec) 520. In some embodiments, codec 520 may be an analog-to-digital (A/D) converter. The output of codec 520 is in communication with digital signal processor (DSP) 530 which is also in communication with controller 540 which, in certain embodiments, may be a microcontroller comprising a microprocessor.

Controller 540 may be in communication with reset button or switch 550 which may be positioned on an external surface of the device for manual activation by a user. One or more indicators, 560 and 570, may be connected to controller 540 for signaling certain events or states to the user. Indicator 560 and/or indicator 570 may be visual indicators examples of which include lights, flags and mechanical shutters which open to expose a colored surface or a graphic symbol. Indicator 560 and/or indicator 570 may also comprise alpha numeric displays, examples of which include liquid crystal displays (LCDs), plasma displays, electroluminescent displays and light-emitting diode (LED) displays.

Indicator 560 and/or indicator 570 may also comprise an audio indicator, examples of which include speakers (in combination with a sound generator or tone generator), buzzers, horns and the like.

Indicator 560 and/or indicator 570 may also comprise a tactile indicator for alerting the user to a certain condition or a change of state. An example of a tactile indicator is a vibrator. The vibrator may comprise an electric motor within the case of the device having an off-center weight attached to its armature shaft.

Indicator 560 may be of the same type or a different type than indicator 570. For example, indicator 560 could be an LED (visual indicator) while indicator 570 is a vibrator (tactile indicator). In some embodiments, the indicator that is activated by the device may be selected by the user. For example, in certain circumstances, a user may desire to be alerted silently to device activation and select a visual indicator and/or a tactile indicator in lieu of an audio indicator. In yet other embodiments, different indicators may be used to signal different activation states of the device. For example, indicator 560 may be a audio indicator used to signal an incoming phone call while indicator 570 is a visual indicator used to signal a waiting voice mail message.

The device may be configured such that activation of reset button 550 by the user deactivates indicator 560 and/or indicator 570 and may reset the state of controller 540. In such a configuration, reset button 550 may function to signal acknowledgement by the user of device activation and to return the device to a state wherein it may monitor incoming audio signals received via microphone 510.

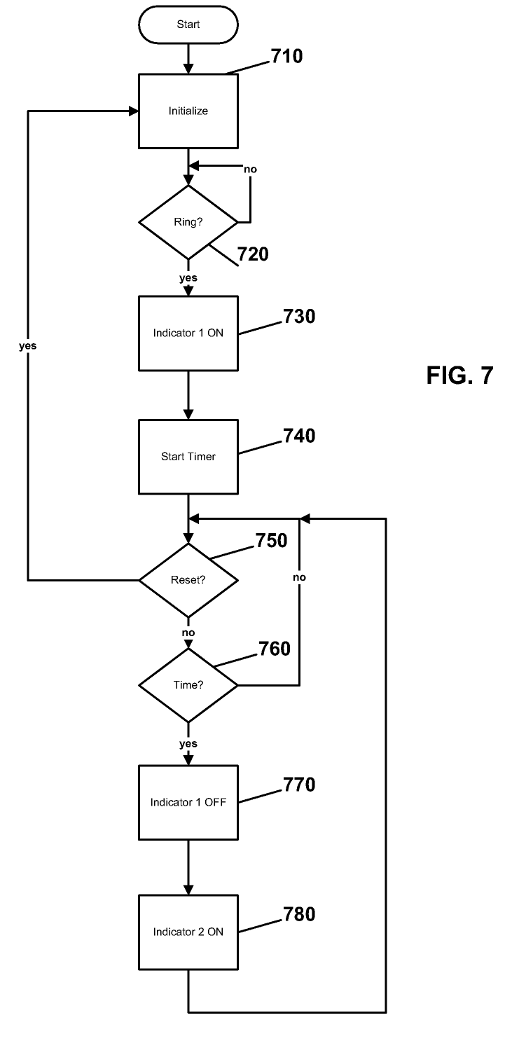

FIG. 7 is a flowchart of a method for monitoring a mobile phone for incoming calls that may be implemented on a device of the type illustrated in FIG. 5. The method illustrated in FIG. 7 includes indicating a missed call.

Upon power-up, the device may go through an initialization routine at step 710. The initialization routine may set the initial state of codec 520, DSP 530 and/or controller 540. In certain embodiments, user activation of reset switch 550 may also cause the device to perform initialization step 710.

Following initialization, the device may enter a state wherein it monitors sounds received by microphone 510 and analyzes such sounds to determine whether a mobile communications device that is within audio range of the device is emitting a certain audio signal—e.g., a ring tone. A sound wave received by microphone 510 may be converted from an analog signal to a digital signal by codec 520. An output signal of codec 520 may be input to digital signal processor 530 which may include a signal level trigger that rejects signals having an intensity (volume) below a selected level—i.e., in certain embodiments, signals that are insufficiently loud to be the ringing of a nearby phone are rejected for further processing. Alternatively, level detection and threshold testing may be performed by codec 520.

DSP 530 may be configured to detect audio signals having a threshold intensity and that fit within pre-selected parameters of a frequency pattern—e.g., an audio pattern that is within an audible frequency range between about 200 Hz to about 15000 Hz or a pattern that is outside a traditionally audible frequency range, between about 15000 Hz to about 25000 Hz. The pattern may be selected to be a common characteristic of often-used ring tones. In certain embodiments, an audio signal known to fit the pattern to which DSP 530 is sensitive may be provided to the user. For example, a ring tone specially selected or created to be recognized by DSP 530 may be provided for downloading to the mobile communications device to be monitored. In this way, the sensitivity and/or selectivity of the monitoring device may be enhanced.

As illustrated in the flowchart of FIG. 7 at decision point 720, the device may wait for a ring to be detected. If a ring is detected (“yes” branch from decision diamond 720), controller 540 may activate indictor 560 at process 730 and start an internal timer at process 740. The device may then enter a state wherein it waits for a reset signal from reset switch 550 (diamond 750) or the expiration of a preset time period since the activation of the timer at step 740 (at decision diamond 760).

If no activation of reset switch 550 is detected within the preset time period (“yes” branch from decision diamond 760), the device may deactivate Indicator 1 (at process 770) and activate Indicator 2 (at process 780). In this way, a missed call may be signaled to the user—a detected ring is signaled to the user by the activation of Indicator 1 (at 730) and if this activation is not acknowledged by the user's closure of reset switch 550 within the pre-selected time period, the ring indicator is turned off (770) and the missed call indicator is turned on (780).

As discussed above, DSP 530 may be configured to detect a generic ring tone or other characteristic sound. This may, however, result in “false positive” indications occasioned by other nearby mobile communications devices that emit a similar audio signal and/or ambient noise. In certain embodiments, this situation may be rectified by providing the monitored mobile communications device with a coded ring tone to which the monitoring device is configured to detect. By way of example, a coded ring tone could be loaded onto a provided Subscriber Identity Module (SIM) smart card which could then be transferred to a mobile phone.

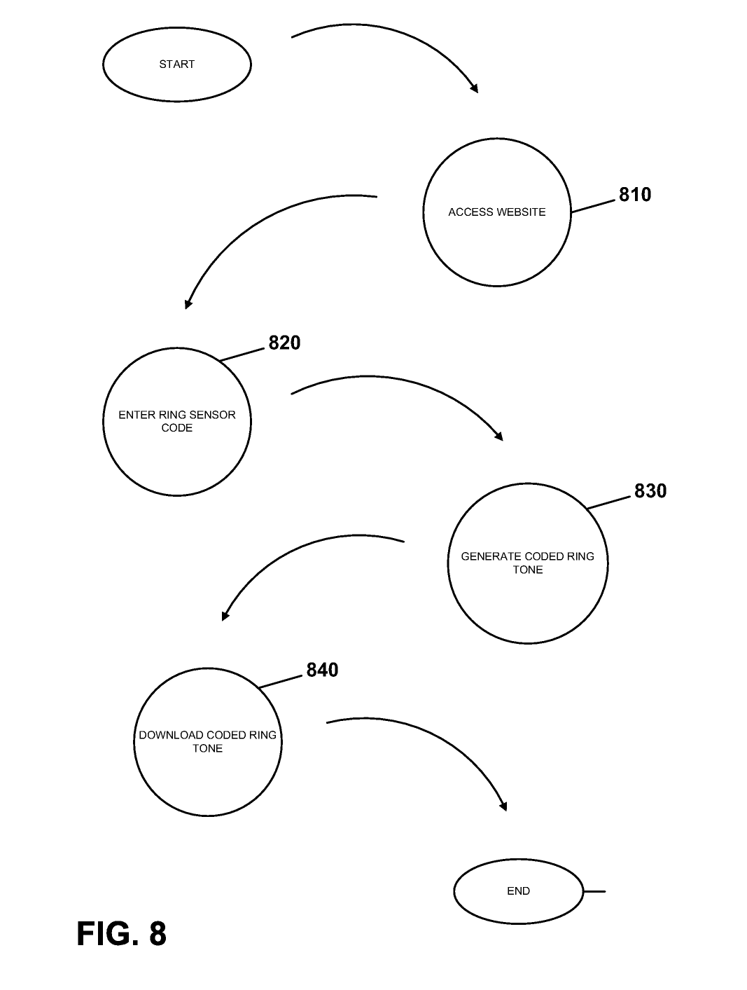

One such process is illustrated step-wise in the diagram of FIG. 8. In this case, each monitoring device according to the invention is provided with a unique code that may be identified to the user by an alphanumeric sequence—e.g., a serial number. The particular alphanumeric sequence may be paired with a code embedded within a ring tone. For example, a code might comprise a certain pattern of alternating frequencies or a pattern of sound intensities. The code may be generated from the alphanumeric sequence by a processor-based system. For example, a user may access a processor-based system via a website (810) where he or she may be prompted to enter the unique alphanumeric sequence associated with his or her monitoring device (820). The system may then generate a unique or semi-unique coded ring tone (830) which the user may then download to his or her mobile communications device (840). DSP 530 of the monitoring device may be preconfigured to respond to detection of the unique or semi-unique ring tone.

A uniquely coded ring tone may be device-specific and thereby provide the lowest probability of a false positive indication. However, even a semi-unique coded ring tone may be used to significantly reduce the likelihood of a false positive indication. For example, devices having even serial numbers may be configured such that DSP 530 is responsive to a ring tone having an embedded code of a first type and devices having odd serial numbers may be configured such that DSP 530 is responsive to a ring tone having an embedded code of a second type. Such a scheme would reduce the probability of a false positive indication by about a factor of 2. Similar schemes for generating semi-unique codes will be apparent to those skilled in the art that may be used to further reduce the probability of false positive indications.

Unique ring tones and/or ring tones having a unique or semi-unique embedded code may also be used to make a device according to the present invention sensitive to a plurality of mobile communications devices or responsive to a plurality of audio signals from a single mobile communications device. For example, a monitoring device may have its DSP 530 configured such that it provides a first signal to controller 540 upon detection of a ring tone having a first embedded code and provides a second signal to controller 540 upon detection of a ring tone having a second embedded code. Controller 540 may be programmed to respond to receipt of a first signal from DSP 530 by activating Indicator 1 (560) and to respond to receipt of a second signal form DSP 530 by activating Indicator 2 (570). One example of such an embodiment is a cell phone having the capability of providing a different ring tone if a call is received from a phone on a pre-selected list of phone numbers versus a call from a phone not on that list. If such ring tones are provided with different embedded codes, a monitoring device according to the present invention may be configured to activate Indicator 1 (560) if an incoming call on the mobile phone is from a number on the list and to activate Indicator 2 (570) if an incoming call is from a number not on the list.

In yet another embodiment, the device may monitor two mobile phones, each having a ring tone having a different embedded code. DSP 530 may respond with different signals to controller 540 upon detecting a ring from a first phone versus a second phone which results in activation of Indicator 1 (560) or Indicator 2 (570), respectively.

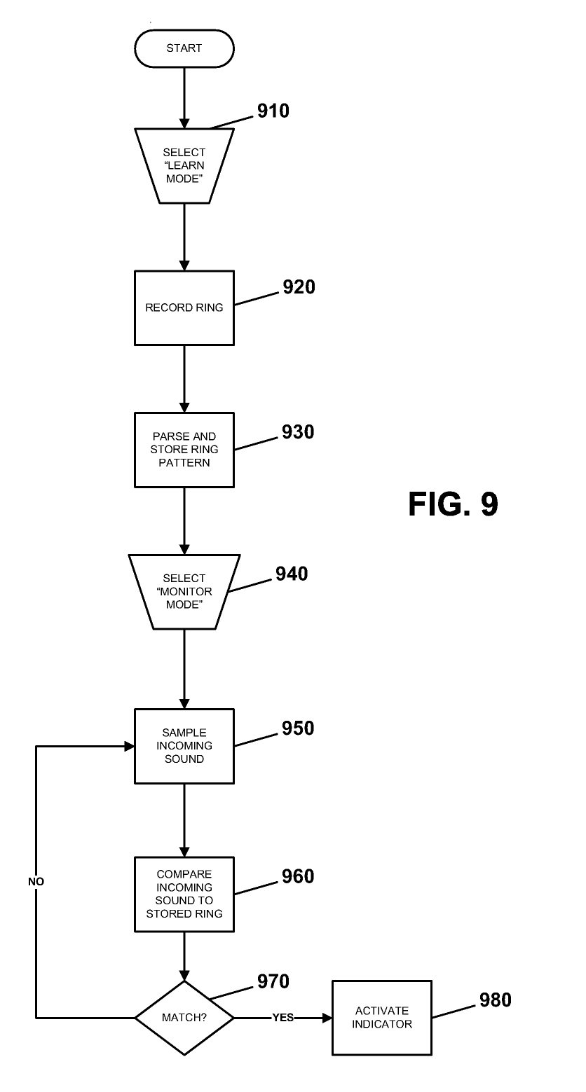

Not all mobile communications devices have the capability of downloading selected ring tones. Certain embodiments of the present invention may be configured to enhance their selectivity to such devices by providing a “listen & learn” mode of operation. The operation of one embodiment of the invention which incorporates this feature is illustrated in the flowchart of FIG. 9.

The process may be implemented by programmed instructions for controller 540 stored within the device. The method may begin with the user selecting a “learn mode” or state at step 910. A separate switch on the device may be provided for this function or, alternatively, it may be implemented by configuring controller 540 to enter this state when a user presses and holds reset button 550 for pre-selected period of time (which may be greater than that required to effect a reset). An dedicated indicator may be provided on the device to indicate to the user that the device has entered the learn mode. Alternatively, a unique activation pattern or tone may be sent to Indicator 1 (560) and/or Indicator 2 (570) to provide confirmation to the user that the unit is in the “learn mode.

Once the user has confirmation that the device is in “learn mode,” he or she may cause the mobile communications device to emit the sound to which the monitoring device is to be sensitized—e.g., a mobile phone may be caused to ring. Preferably the devices are placed or held in proximity to one another in order to ensure adequate reception of the audio signal. The monitoring device records the ring (or other sound) at step 920. In certain embodiments, a pre-selected sound intensity threshold may be used to initiate recording after “learn mode” is entered.

At step 930 in the illustrated embodiment of FIG. 9, the device parses the recorded ring tone for pattern characteristics and then stores the relevant parameters in on-board memory. The user may then select “monitor mode” for the device (at step 940) using a dedicated switch or, as discussed above, by activating reset switch 550. Alternatively, the device may be configured to automatically return to “monitor mode” after steps 920 and 930 have been completed.

As in the previous example, the device may now sample incoming sounds (step 950) and then compare the incoming sound to the sound recorded, parsed and stored in steps 920 and 930. If the sound comparison meets pre-selected criteria for a match (970), the device may activate an indicator (980). If the sampled sound does not satisfy the pre-selected criteria for a match (“no” branch at decision diamond 970), the device resumes sampling incoming sounds at process 950. As in other embodiments described previously, the sampling of incoming sounds (step 950) may be triggered by a received sound exceeding a pre-selected intensity level.

It will be appreciated by those skilled in the art that a plurality of sounds may be recorded, parsed and stored and subsequently compared to incoming sounds. In this way the device may distinguish incoming sounds and provide different indications to the user upon receipt of different, recognized audio signals. For example, the device may “learn” a first audio signal and associate it with Indicator 1 and “learn” a second audio signal and associate it with Indicator 2. In one representative embodiment, a first audio signal may be emitted by the monitored device when there is an incoming voice call and a second audio signal may be emitted by the monitored device when a text message is received via the Short Message System (SMS). These two events may trigger separate and distinct indications by the monitoring device.

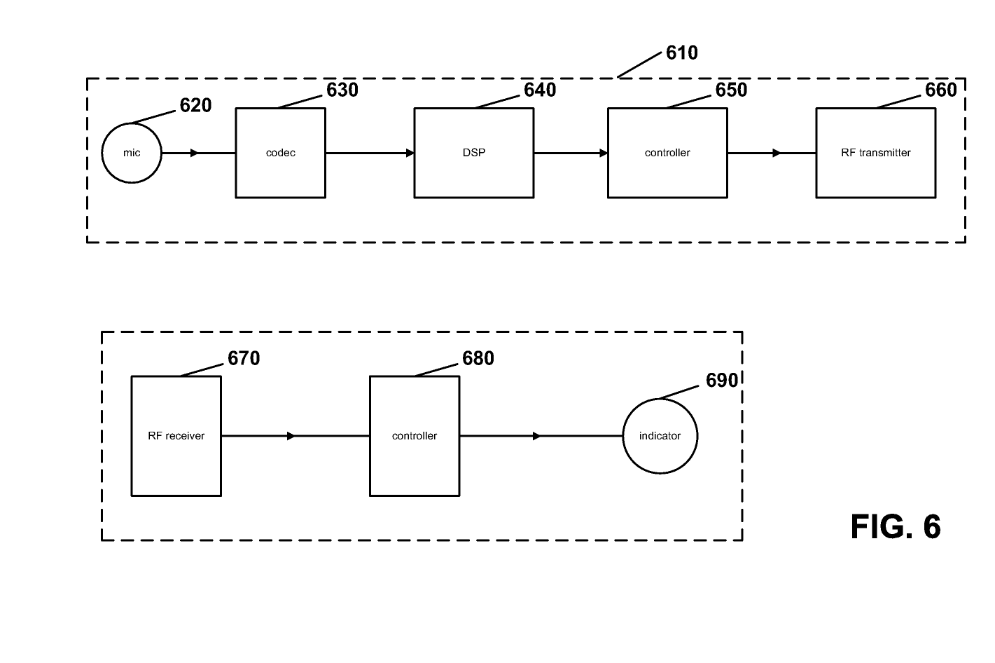

Yet another embodiment of the invention is illustrated in FIG. 6. In this embodiment the circuitry associated with the monitoring functions of the device is in a separate package from the circuitry for the indicating functions of the device. The two packages communicate over a radio-frequency link. Such an arrangement may provide the device with significantly enhanced range.

As shown in FIG. 6, audio monitor 610 comprises microphone 620, codec 630, DSP 640 and controller 650. These components correspond to elements 510, 520, 530 and 540, respectively, of the embodiment illustrated in FIG. 5. However, controller 650 is connected to radio frequency transmitter 660 which provides an rf-link to radio frequency receiver 670 in unit 615. Unit 615 also comprises controller 680 and indicator 690. Signaling unit 615 may be worn or carried by the user while monitoring unit 610 may be placed in physical proximity to the mobile communications device being monitored. An illustrative situation is a mobile phone and monitoring unit 610 together in a user's purse or briefcase and indicator unit 615 being worn on the person of the user.

In certain embodiments, elements 660 and 670 may comprise transceivers for establishing a two-way link between the devices. In this way “handshaking” signals may be exchanged between the two units and/or an acknowledgement or reset signal may be sent from indicator unit 615 to monitor unit 610.

The radio frequency link may utilize a proprietary protocol or may utilize a standard protocol such as Bluetooth (an industrial specification for wireless personal area networks, also known as IEEE 802.15.1.), WiMAX (defined as Worldwide Interoperability for Microwave Access by the WiMAX Forum, formed in June 2001 to promote conformance and interoperability of the IEEE 802.16 standard), or WiFi (Wireless Fidelity), which like WiMAX, is a certification mark for equipment based on a different set of IEEE standards from the 802.11 working group for wireless local area networks. The radio frequency link may be a direct link between the two devices or may utilize an existing wireless network.

Indicator unit 615 may be a stand alone device or may be incorporated into an article of clothing or a clothing accessory. Representative examples include a watch, a bracelet, a charm for mounting on a charm bracelet, a pin or brooch, a necklace, a pendant for mounting on a necklace, an adhesive skin patch, and a clip-on device. The circuitry and power source for indicator unit 615 may be sewn within a garment or accessory, for example a hat or scarf.

Sensing unit 610 may be packaged for convenient physical association with a mobile communications device. For example, unit 610 may be configured to attach to a mobile communications device with a fastening device (for example, clips, straps, hook-and-loop fasteners). Alternatively, unit 610 may be configured as a holder for a mobile communications device.

Although the invention has been described in detail with reference to certain preferred embodiments, variations and modifications exist within the scope and spirit of the invention as described and defined in the following claims.

What is claimed is:

1. An audio signal monitor for a mobile communications device comprising:
a sensor responsive to an audio signal emitted by a selected mobile communications device;
an indicator selected from the group consisting of visual indicators, audio indicators and tactile indicators coupled to the sensor such that the indicator is activated upon receipt by the sensor of a pre-selected audio signal emitted by the selected mobile communications device.

2. An audio signal monitor for a mobile communications device comprising:
a processor;
a digital signal processor connected to the processor;
an analog-to-digital converter connected to the digital signal processor;
a microphone connected to the analog-to-digital converter;
an indicator responsive to a signal from the processor;
a medium storing instructions for causing the processor to
compare a signal received from the digital signal processor to one or more predefined criteria and
activate the indicator if the comparison satisfies a preset condition.

3. An audio signal monitor as recited in claim 2 wherein the predefined criteria correspond to the characteristics of a ring tone produced by a mobile phone.

4. An audio signal monitor as recited in claim 2 wherein the indicator is a visual indicator.

5. An audio signal monitor as recited in claim 2 wherein the indicator is a tactile indicator.

6. An audio signal monitor as recited in claim 2 wherein the indicator is an auditory indicator.

7. An audio signal monitor as recited in claim 2 further comprising a fashion accessory having an interior space containing the processor, the digital signal processor, the analog-to-digital converter, the microphone, the indicator and the medium storing instructions.

8. An audio signal monitor as recited in claim 2 further comprising an adhesive-backed package having an interior space containing the processor, the digital signal processor, the analog-to-digital converter, the microphone, the indicator and the medium storing instructions.

9. An audio signal monitor as recited in claim 2 wherein the predefined criteria correspond to pre-selected characteristics of a downloadable ring tone for a mobile communications device.

10. An audio signal monitor as recited in claim 2 wherein the predefined criteria correspond to a code contained within a downloadable ring tone.

11. An audio signal monitor for a mobile communications device comprising:
a processor;
a digital signal processor connected to the processor;
an analog-to-digital converter connected to the digital signal processor;
a microphone connected to the analog-to-digital converter;
a radio-frequency transmitter connected to the processor;
a medium storing instructions for causing the processor to
compare a signal received from the digital signal processor to one or more predefined criteria and
send a pre-selected signal from the transmitter if the comparison satisfies a preset condition;
a radio-frequency receiver; and,
an indicator responsive to a signal from the radio-frequency receiver.

12. An audio signal monitor as recited in claim 11 wherein the processor, the digital signal processor, the microphone, the transmitter and the medium storing instructions are contained within a first housing and the receiver and the indicator are contained within a second housing.

13. An audio signal monitor for a mobile communications device comprising:
a processor;
a digital signal processor connected to the processor;
an analog-to-digital converter connected to the digital signal processor;
a microphone connected to the analog-to-digital converter;
a first radio-frequency transceiver connected to the processor;
a medium storing instructions for causing the processor to
compare a signal received from the digital signal processor to one or more predefined criteria and
send a pre-selected signal from the transmitter if the comparison satisfies a preset condition;
a second radio-frequency transceiver; and,
an indicator responsive to a signal from the second transceiver.

14. An audio signal monitor for a mobile communications device as recited in claim 13 wherein the first transceiver and the second transceiver are configured to communicate via a wireless network.

15. A method for monitoring audio signals from a mobile communications device comprising:
configuring an audio sensor to respond to a pre-selected ring tone; and, downloading the pre-selected ring tone to a mobile communications device.

16. A method as recited in claim 15 wherein the pre-selected ring tone comprises an audio signal associated with one or more audio sensors belonging to a pre-selected group of audio sensors.

17. A method for monitoring audio signals from a mobile communications device comprising:
configuring an audio sensor to respond to a ring tone comprising a coded signal;
inputting an identifier associated with the audio sensor into a processor-based system;
generating a ring tone comprising the coded signal on the processor-based system;
downloading the ring tone from the processor-based system to a mobile communications device.

18. A method as recited in claim 17 wherein generating a ring tone comprising the coded signal comprises a mathematical function of the identifier.

19. A method as recited in claim 17 wherein inputting an identifier associated with the audio sensor and downloading the ring tone comprise communicating via a global computer network.

20. A method as recited in claim 17 further comprising presenting a selection of ring tones for user selection.
